(19) United States
(12) Patent Application Publication
(10) Pub. No.: US 2007/0103595 A1
(43) Pub. Date: May 10, 2007

(54) VIDEO SUPER-RESOLUTION USING PERSONALIZED DICTIONARY

(76) Inventors: Yihong Gong, (US); Mei Han, (US); Dan Kong, (US); Hai Tao, (US); Wei Xu, (US)

Correspondence Address: BROSEMER, KOLEFAS & ASSOCIATES, LLC (NECL), ONE BETHANY ROAD BUILDING 4 - SUITE #58, HAZLET, NJ, 07730, US

(21) Appl. No.: 11/553,552

(22) Filed: Oct. 27, 2006

Related U.S. Application Data
(60) Provisional application No. 60/730,731, filed on Oct. 27, 2005.

(51) Int. Cl. H04N 5/00

(52) U.S. Cl. 348/620

(57) ABSTRACT

A video super-resolution method that combines information from different spatial-temporal resolution cameras by constructing a personalized dictionary from a high resolution image of a scene resulting in a domain specific prior that performs better than a general dictionary built from images.

### CROSS REFERENCE TO RELATED APPLICATIONS

This application claims the benefit of U.S. Provisional Patent Application No. 60/730,731 filed Oct. 27, 2005 the entire contents and file wrapper of which are incorporated by reference as if set forth at length herein.

### FIELD OF THE INVENTION

This invention relates generally to the field of video processing and in particular relates to a method for improving the spatial resolution of video sequences.

### BACKGROUND OF THE INVENTION

Video cameras—while quite sophisticated—nevertheless exhibit only limited spatial and temporal resolution. As understood by those skilled in the art, the special resolution of a video camera is determined by the spatial density of detectors used in the camera and a point spread function (PSF) of imaging systems employed. The temporal resolution of the camera is determined by the frame-rate and exposure time. These factors—and others—determine a minimal size of spatial features or objects that can be visually detected in an image produced by the camera and the maximum speed of dynamic events that can be observed in a video sequence, respectively.

One direct way to increase spatial resolution is to reduce pixel size (i.e., increase the number of pixels per unit area) by any of a number of known manufacturing techniques. As pixel size decreases however, the amount of light available also decreases which in turn produces shot noise that unfortunately degrades image quality. Another way to enhance the spatial resolution is to increase the chip size of the sensor containing the pixels, which substantially adds to its cost—for most applications.

An approach to enhancing spatial resolution which has shown promise employs image processing techniques. That approach—called Super-resolution—is a process by which a higher resolution image is generated from lower resolution ones. (See., e.g., J. Sun, N-N. Zheng, H. Tao and H. Shum, Image Hallucination With Primal Sketch Priors, Proc. CVPR'2003, 2003).

Many prior art super-resolution methods employ reconstruction-based algorithms which themselves are based on sampling theorems. (See, e.g., S. Baker and T. Kanade, Limits On Super-Resolution And How To Break Them, IEEE Trans. Pattern Analysis and Machine Intelligence, 24(9), 2002). As a result of constraints imposed upon motion models of the input video sequences however, it is oftentimes difficult to apply these reconstruction-based algorithms. In particular, most such algorithms have assumed that image pairs are related by global parametric transformations (e.g., an affine transform) which may not be satisfied in dynamic video sequences.

Those skilled in the art will readily appreciate how challenging it is to design super-resolution algorithms for video sequences selected from arbitrary scenes. More specifically, video frames typically cannot be related through global parametric motions due—in part—to unpredictable movement of individual pixels between image pairs. As a result, an accurate alignment is believed to be a key to success of reconstruction-based super-resolution algorithms.

In addiction, for video sequences containing multiple moving objects, a single parametric model has proven insufficient. In such cases, motion segmentation is required to associate a motion model with each segmented object, which has proven extremely difficult to achieve in practice.

### SUMMARY OF THE INVENTION

An advance is made in the art according to the principles of the present invention which is directed to a efficient super resolution method for both static and dynamic video sequences wherein—and in sharp contrast to the prior art—a training dictionary is constructed from a video scene itself instead of general image pairs.

According to aspect of the present invention, the training dictionary is constructed by selecting high spatial resolution images captured by high-quality still cameras and using these images as training examples. These training examples are subsequently used to enhance lower resolution video sequences captured by a video camera. Therefore, information from different types of cameras having different spatial-temporal resolution is combined to enhance lower resolution video images.

According to yet another aspect of the present invention, spatial-temporal constraints are employed to regularize super-resolution results and enforce consistency both in spatial and temporal dimensions. Advantageously, super resolution results so produced are much smoother and continuous as compared with prior-art methods employing the independent reconstruction of successive frames.

### DESCRIPTION OF THE DRAWING

Further features and aspects of the present invention may be understood with reference to the accompanying drawing in which:

FIG. 1 shows the steps associated with an exemplary embodiment of the present invention;

FIG. 2 shows the result of applying spatial-temporal constraints and its affect on consistent results before consecutive frames;

FIG. 3 shows the super resolution results for frames 12, 46 and 86 from a sequence for (3 times magnification in both directions) (a) input low resolution frames (240×160); (b) bi-cubic interpolation results (720×480) and (c) results using personalized dictionary+spatial temporal constraint (720×480); result of applying spatial-temporal constraints and its affect on consistent results before consecutive frames;

FIG. 4 shows the super resolution results for frame 3, 55, and 106 from a face video sequence (3 times magnification in both directions) for (a) input low resolution frames (240×160); (b) bi-cubic interpolation results (720×480) and (c) results using personalized dictionary+spatial temporal constraint (720×480);

FIG. 5 shows the super resolution results for frame 11, 40, 92 and 126 from a keyboard video sequence (4 times magnification in both directions) for (a) input low resolution frames (160×120); (b) bi-cubic interpolation results (640×480) and (c) results using personalized dictionary+spatial temporal constraint (640×480); and

FIG. 6 shows a graph depicting RMS errors for first 20 frames of plant video sequence (left) and face video sequence (right);

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

By way of providing some additional background, it is noted that existing super-resolution algorithms can be roughly divided into two main categories namely, reconstruction-based and learning-based. In addition, the reconstruction-based algorithms may be further divided into at least two classes based upon the underlying image(s) including: 1) resolution enhancement from a single image and 2) super-resolution from a sequence of images.

Reconstruction-based super-resolution algorithms employ known principles of uniform/non-uniform sampling theories. These principles assume that an original high-resolution image can be well predicted from one or more low resolution input images. Several super-resolution algorithms fall into this category (See, e.g., R. Tsai et al., “Multi-frame Image Restoration and Registration”, Advances in Computer Vision and Image Processing, pp. 317-339, 1984; M. Irani and S. Peleg, “Improving Resolution by Image Registration”, Journal of Computer Vision, Graphics and Image Processing, 53(3):231-239, 1991; M. Irani and S. Peleg, “Motion Analysis for Image Enhancement: Resolution, Occlusion, and Transparency”, Journal of Visual Communication and Image Representation, 4(4): 324-335, 1993; M. Elad and A. Feuer, “Restoration Of Single Super-Resolution Image From Several Blurred, Noisy and Down-Sampled Measured Images, “IEEE Trans. On Image Processing”, 6(12), 1646-1658, 1997; A. Patti, M. Zezan and A. Tekalp, “Superresolution Video Reconstruction With Arbitrary Sampling Lattices and Nonzero Aperture Time”, IEEE Trans on Image Processing, 6(8): 1064-1076, 1997; D. Capel and A. Zisserman, “Super-Resolution Enhancement of Text Image Sequence”, Proc. ICPR'2000, pp. 600-605, 2000; M. Elad and A. Feuer, “Super-Resolution Reconstruction of Image Sequences”, IEEE Trans Pattern Analysis and Machine Intelligence, 21(9):817-834, 1999; and R. Schultz and R. Stevenson, “Extraction of High Resolution Frames from Video Sequences”, IEEE Trans. On Image Processing, 5(6):996-1011, 1996). And while each of the algorithms shares certain similarities with one or more of the others, in practice they may differ in the number and type of images used, i.e., a single image, a sequence of images, a video, a dynamic scene, etc. A more detailed review may be found in S. Borman and R. Stevenson, “Spatial Resolution Enhancement of Low Resolution Image Sequences: A Comprehensive Review with Directions for Future Research”, Technical Report, University of Notre Dame, 1998.

Mathematically, such problems are difficult when the resolution enhancement factor is high or the number low resolution frames is small. Consequently, the use of Bayesian techniques and generic smoothness assumptions about high resolution images are employed. Among them, frequency domain methods and iterative back-projection methods have been used. Lastly, a unifying framework for super-resolution using matrix-vector notation has been discussed.

More recently however, learning based super-resolution has been applied to both single image and video. Underlying these techniques is the use of a training set of high resolution images and their low resolution counterparts to build a training dictionary. With such learning based methods, the task is to predict high resolution data from observed low resolution data.

Along these lines, several methods have been proposed for specific types of scenes, such as faces and text. Recently, Freeman et al. [in an article entitled “Example Based Super-Resolution”, which appeared in IEEE Computer Graphics and application, 2002, proposed an approach for interpolating high-frequency details from a training set. A somewhat direct application of this to video sequences was attempted (See, e.g., D. Capel and A. Zisserman, “Super-Resolution From Multiple Views Using Learnt Image Models”, Proc. CVPR'2001, pp. 627-634, 2001), but severe video artifacts unfortunately resulted.

In an attempt to remedy these artifacts, an ad-hoc method that reused high resolution thereby achieving more coherent videos was developed. In contrast to earlier methods that produced the artifacts, the super-resolution is determined through probabilistic inference, in which the high resolution video is found using a spatial-temporal graphical model (See, e.g., A. Herzmann, C. E. Jacobs, N. Oliver, B. Curless and D. H. Salesin, “Image Analogies”, Proc. SIGGRAPH, 2001).

In describing the super-resolution method that is the subject of the present invention, it is noted first that different space-time resolution can provide complementary information. Thus, for example, the method of the present invention may advantageously combine information obtained by high-quality still cameras (which have very high spatial-resolution, but extremely low temporal-resolution), with information obtained from standard video cameras (which have low spatial-resolution but higher temporal resolution), to obtain an improved video sequences of both high spatial and high temporal resolution. This principle is also employed in a method described in Irani's work on spacetime which increases the resolution both in time and in space by combining information from multiple video sequences of dynamic scenes.

A second observation worth noting is that learning approaches can be made much more powerful when images are limited to a particular domain. In particular and due—in part—to the intrinsic ill-posed property of super-resolution, prior models of images play important role in regularizing the results. However it must be noted that modeling image priors is quite challenging due to the high-dimensionality of images, their non-Gaussian statistics, and the need to model correlations in image structure over extended neighborhoods. This is but one reason why a number of prior art super-resolution algorithms employing smoothness assumption fail since they only capture firstorder statistics.

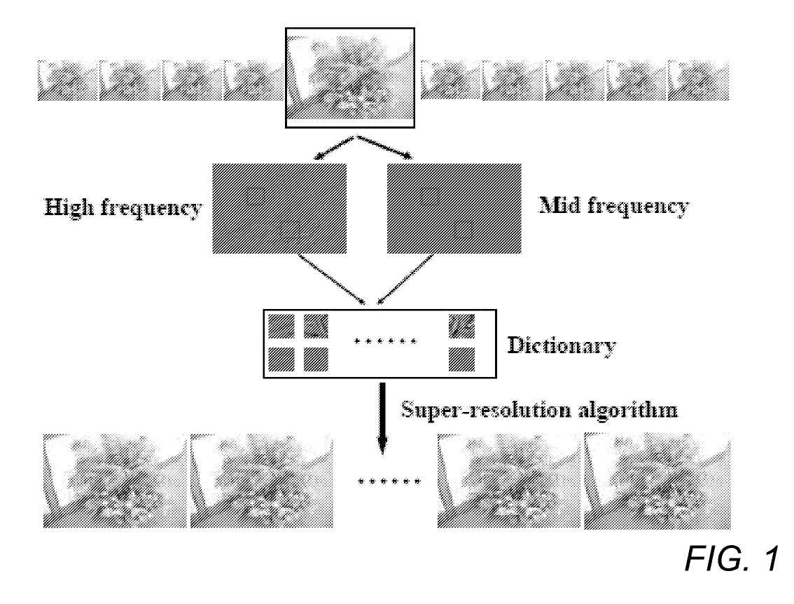

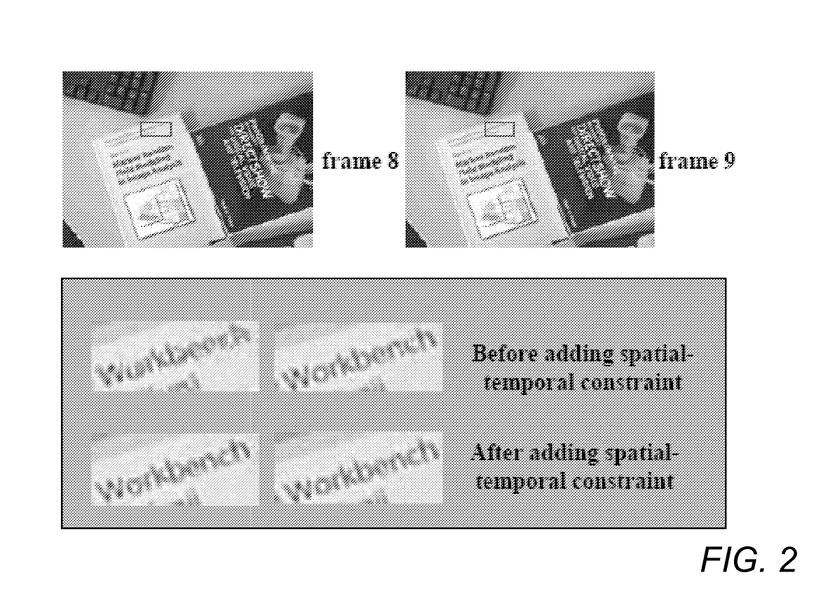

Learning-based models however, such as that which is the subject of the present invention, represent image priors using patch examples. An overview of our approach is shown in FIG. 1. With reference to that FIG. 1, there it is shown that one embodiment of the present invention may include three steps. More particularly—in step 1—a buffer is first filled with low resolution video frames and a high spatial resolution frame that is captured by still camera during this time is used to construct a dictionary.

In step 2, high frequency details are added to the low resolution video frames based on the personalized dictionary with spatial-temporal constraint(s) being considered. Finally, in step 3, the reconstruction constraint is reinforced to thereby obtain final high resolution video frames. While not specifically shown in the overview of FIG. 1, according to the present invention, only sparse high resolution images are available and utilized.

As can be appreciated by those skilled in the art, a primal-sketch based hallucination is similar to face hallucination and other related lower level learning work(s). The basic idea with this method is to represent the priors of image primitives (edge, corner etc.) using examples and that the hallucination is only applied to the primitive layer.

There are a number of reasons to focus only on primitives instead of arbitrary image patches. First human visual systems are very sensitive to image primitives when going from low resolution to high resolution. Second, recent progress on natural image statistics shows that the intrinsic dimensionality of image primitives is very low. Advantageously, low dimensionality makes it possible to represent well all the image primitives in natural images by a small number of examples. Finally, we want the algorithm to be fast and run in real-time. Focusing on the primitives permits this.

Operationally, a low resolution image is interpolated as the low frequency part of a high resolution image. This low frequency image is then decomposed into a low frequency primitive layer and a non-primitive layer. Each primitive in the primitive layer is recognized as part of a subclass, e.g. an edge, a ridge or a corner at different orientations/scales. For each primitive class, its training data (i.e., high frequency and low frequency primitive pairs) are collected from a set of natural images.

Additionally for the input low resolution image, a set of candidate high frequency primitives are selected from the training data based on low frequency primitives. The high frequency primitive layer is synthesized using the set of candidate primitives. Finally, the superresolution image is obtained by combining the high frequency primitive layer with the low frequency image, followed by a back-projection while enforcing the reconstruction constraint.

As already noted, the performance of a learning-based approach is dependent on the priors used. Specifically, when training samples are used, the priors are represented by a set of examples in a non-parametric way. In addition, the generalization of training data is necessary to perform hallucination for the generic image.

There are at least two factors that determine the success rate of example-based super-resolution. The first is sufficiency, which determines whether or not an input sample can find a good match in the training dictionary. As can be appreciated, one advantage of primal-sketch over arbitrary image patch may be demonstrated from a statistical analysis on a set of empirical data. One may conclude from such an analysis that that primal sketch priors can be learned well from a number of examples that are computationally affordable.

A second factor is predictability, which measures the randomness of the mapping between high resolution and corresponding low resolution patches. For super-resolution, the relationship is many-to-one, since many high resolution patches—when—smoothed and down-sampled, will give the same low resolution patch. Higher predictability means lower randomness of the mapping relationship. Advantageously, with the approach provided by the present invention, both sufficiency and predictability are improved by constructing the training data using high resolution images from a particular scene. In addition, the personalized dictionary provides a domain-specific prior and is adaptively updated over time.

Advantageously—and according to the present invention—fewer examples are required to achieve sufficiency and predictability is increased dramatically. In comparing the operation of the method of the instant application employing the personalized dictionary with a general dictionary, we use a Receiver Operating Characteristics (ROC) curve to demonstrate the tradeoff between hit rate and match error. The results show that the personalized dictionary outperforms the general dictionary in terms of both nearest-neighbor search and high resolution prediction.

In order to produce a smooth super-resolved video sequence and reduce any flickering between adjacent frames, the spatial-temporal constraint is integrated into the method of the present invention. To accomplish this, an energy function is defined as:

$$E = {\sum }_{i} ( α C ( {p}_{i} , {p}_{i} ) + β {\sum }_{s ∈ {N}_{( i )}} C ( {q}_{i} , {q}_{s} ) + γ {\sum }_{t ∈ {N}_{( i )}^{′}} C ( {q}_{i} , {q}_{t} ) ) \qquad [ 1 ]$$

Here, the first term is the matching cost between the input low-resolution patch and the low-resolution patch in the dictionary. The second and third terms measures the compatibility between the current high-resolution patch and its spatial and temporal neighborhoods.

The tempneighborhood is determined by computing an optical flow between the B-spline interpolated frames. All the cost functions are computed using SSD. To optimize this cost function, k-best matching pairs are selected from the dictionary for each low resolution patch and the optimal solution is then found by iteratively updating the candidate high resolution patches at each position.

To show how the spatial-temporal constraint can improve the results, we zoom into a region of interest of two adjacent frames, as shown in FIG. 2. As can be seen from this FIG. 2, more coherent solutions are obtained by adding spatial temporal constraint.

Our inventive super-resolution implemented on commercially available personal computer hardware (1.6 GHz Pentium IV processor) along with the open source computer vision library OpenCV and DirectShow. The system was run using a tvideo sequence at the rate of 2 frames per second without optimized code. A number of variable and parameter settings were adjusted to affect its performance.

The training dictionaries were derived from high resolution frames captured by high quality still camera. The original high resolution images are decomposed into three frequency band: low, middle and high frequency and it is assumed that the high frequency is conditionally independent of the low frequency.

To reduce the dimensionality of primitives, we also assume that any statistical relationship between low frequency primitives and high frequency primitives is independent of some transformations including contrast, DC bias, and translation. The variance of the Gaussian kernel we used to blur and down-sample takes value of 1.8 and the high-pass filter we used to remove the low-frequency from the B-spline interpolated image has window size of 11×11. The patch size for each high-resolution and low-resolution pair is 9×9.

To normalize the patch pairs, we divided it by the energy of the low-resolution patch. This energy is the average absolute value of the low resolution patch:

$$energy = 0.01 + \sum \vert {c}_{i} \vert / N \qquad [ 2 ]$$

To accommodate motions in the scene, each patch is rotated by 90, 180 and 270 degrees respectively. The whole dictionary is organized as a hierarchical kd-tree. The top level captures the primitive's global structures like edge orientations and scales. The bottom level is a non-parametric representation that captures the local variance of the primitives. This two-level structure can speed up the ANN tree searching algorithm [1] in the training dictionary.

In addition, to further speed up the algorithm, we applied principle component analysis (PCA) on the training data and stores the PCA coefficients instead of original patches in the dictionary.

For the low resolution frames in the buffer, we synthesized their high frequency counterparts sequentially to enforce temporal constraint. Advantageously, straightforward, known nearest neighbor algorithms can be used for this task. For each low frequency primitive, we first contrast normalize it and then find the K best matched normalized low frequency primitive and the corresponding high frequency primitive in the training data. The final decisions are made among the K candidates by optimizing the spatial-temporal energy function defined in equation [1]. After the high frequency layer is synthesized, we add it to the B-spline interpolated layer to obtain the hallucinated high resolution frame. Finally, we enforce reconstruction constraint on the result by applying back-projection, which is an iterative gradient-based minimization method to minimize the reconstruction error.

It is noted and as can now be appreciated by those skilled in the art, learning approaches can be made much more powerful when images are limited to a particular domain. Due to the intrinsic ill-posed property of super-resolution, prior models of images may play an important role in regularizing the results. However, modeling image priors is oftentimes difficult due to the high-dimensionality of images, their non-Gaussian statistics, and the need to model correlations in image structure over extended neighborhoods.

As can be further appreciated, this is but one reason why a number of prior art super-resolution methods using smoothness assumptions fail since they only capture the firstorder statistics.

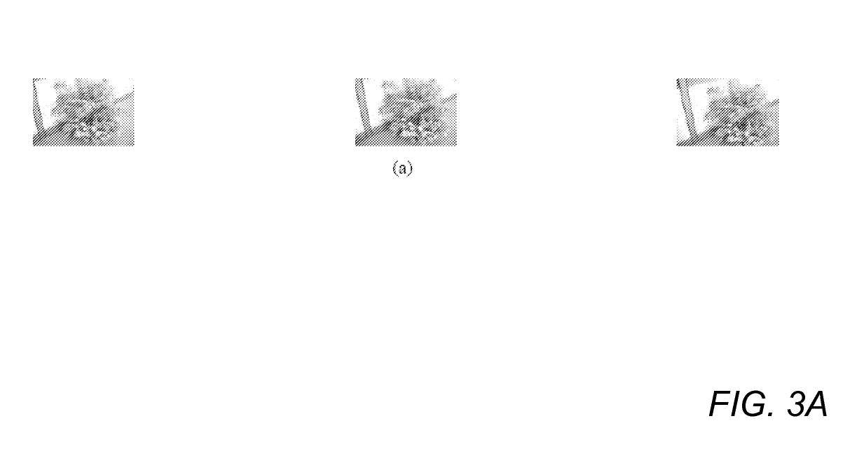

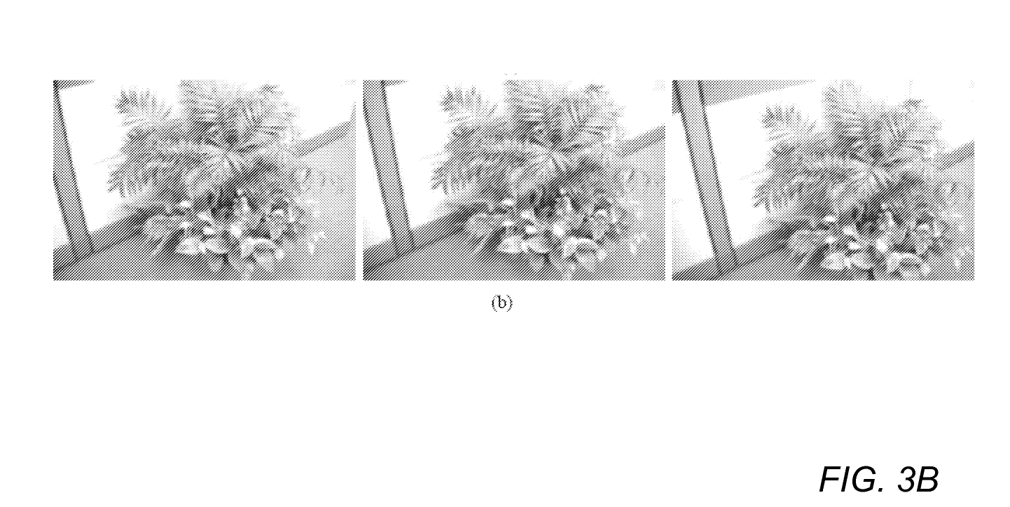

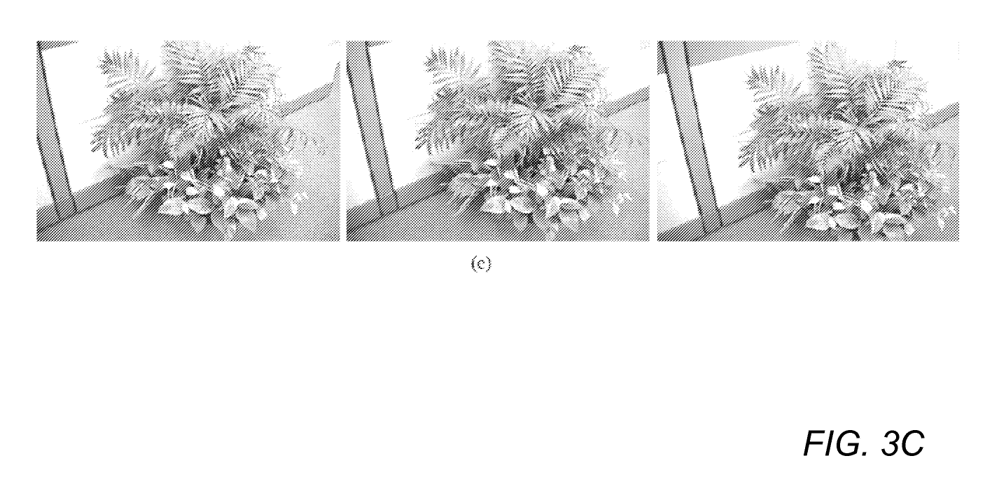

We can now show some experimental results based on the method of the present application and compare them with Bi-cubic interpolation method. The method was applied to three video clips. The first one is made by a commercially available video camcorder. To simulate a hybrid camera and perform the evaluation, the video was shot at high resolution 720×480. Every 15 frames, the high resolution image is kept and the resolution of other frames is 240×160. The high resolution frame is used to construct a dictionary and increase the resolution of other frames three times in both dimensions. FIG. 3 shows the result for three frames from the plant sequence. It can be seen that present method outperform the Bi-cubic interpolation by recovering sharp details of the scene.

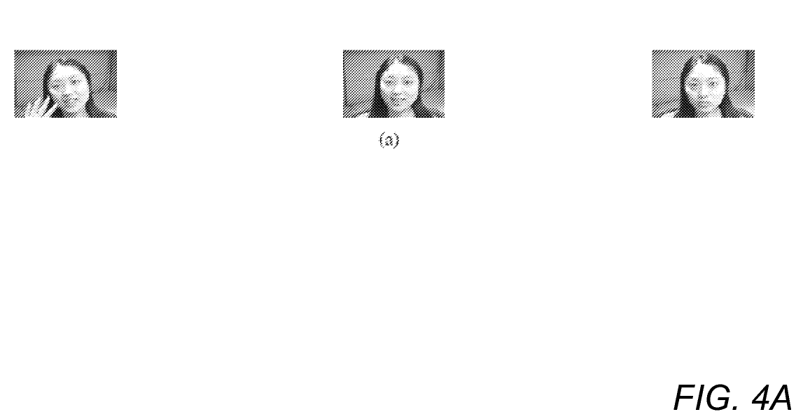

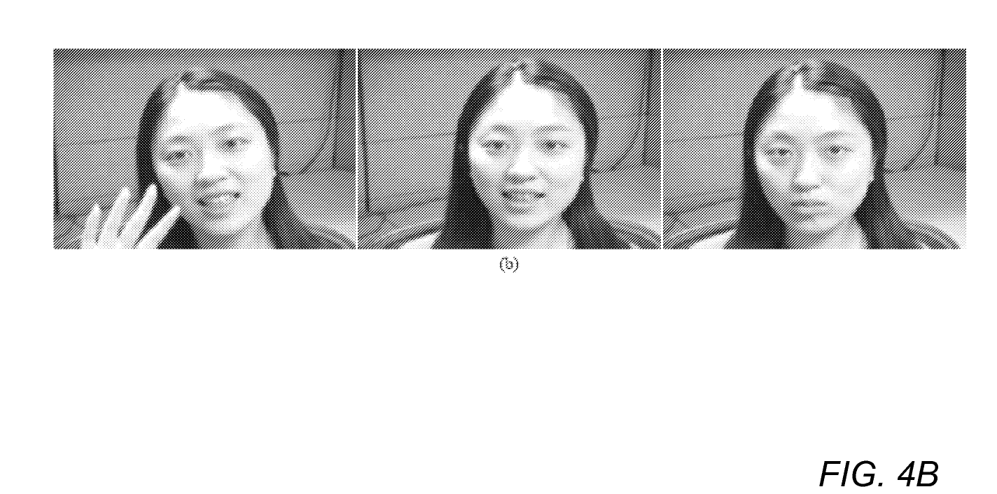

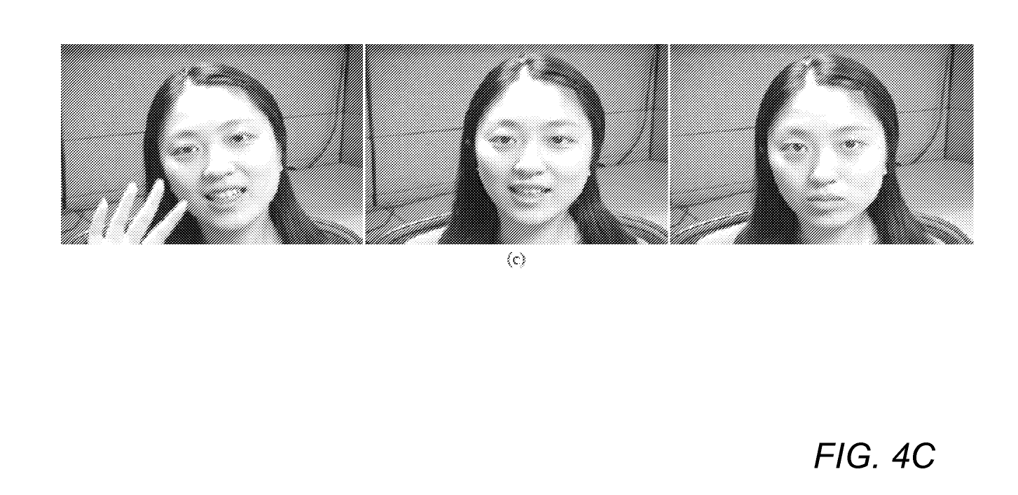

The second clip is taken by the same camcorder but capturing the dynamic scene this time. Again, the spatial resolution is increased three times in both directions while preserving the high frequency on the face, as shown in FIG. 4.

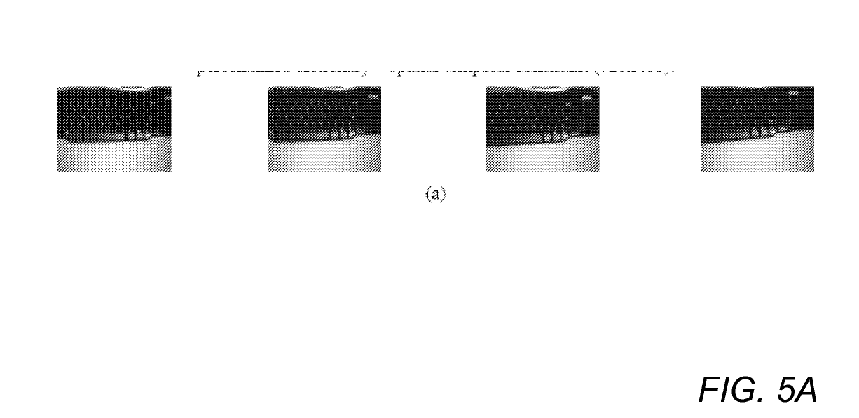

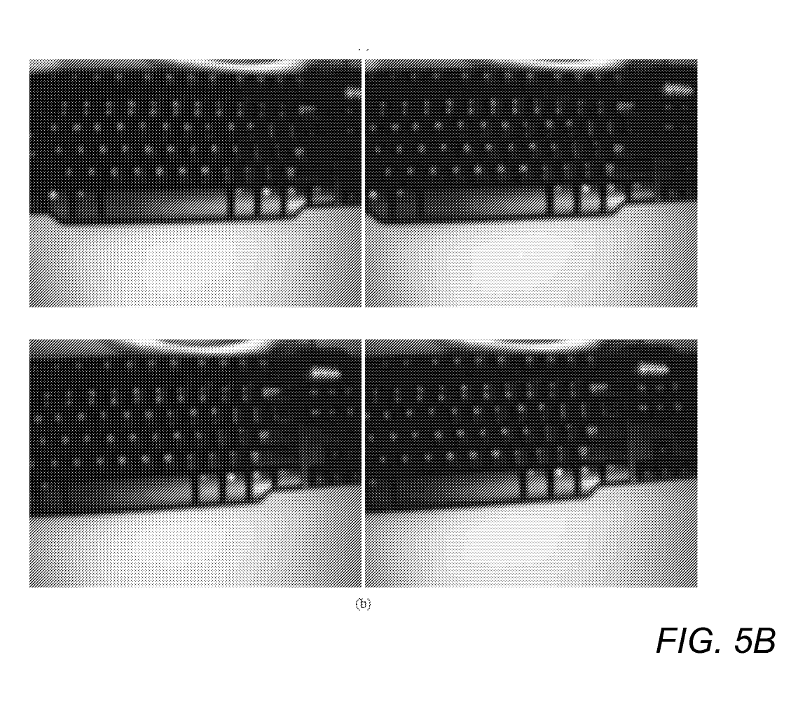

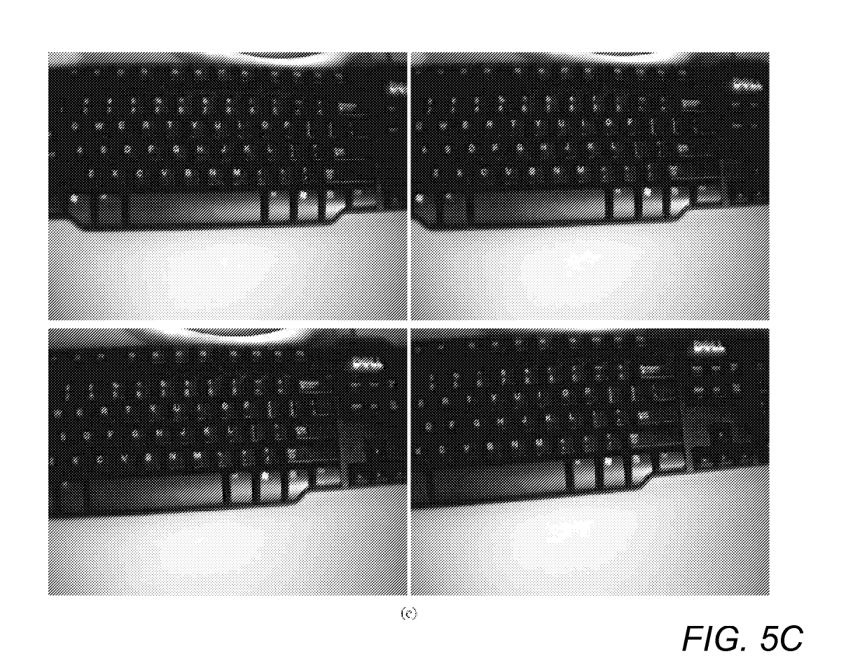

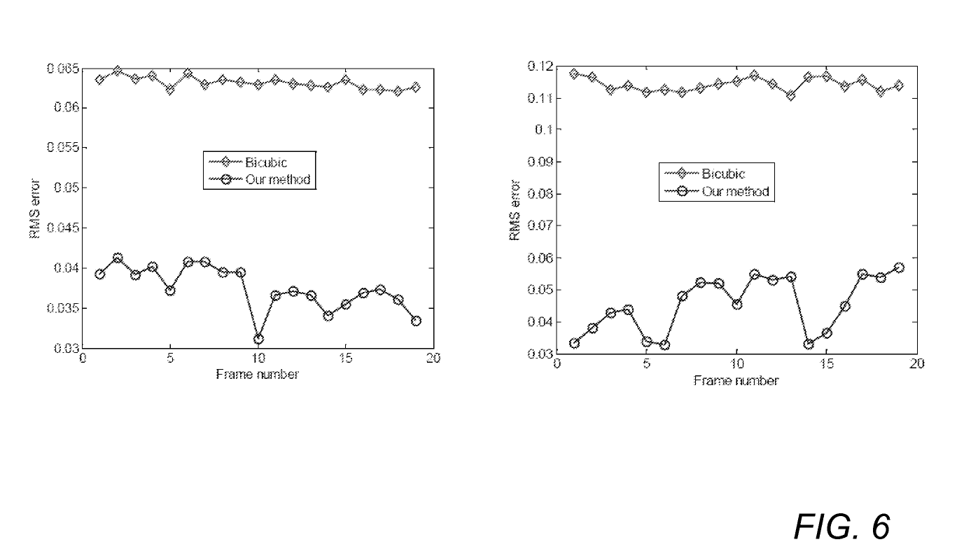

The final evaluation was made using a commercially available, USB web camera. This camera can take 30 frames/s video with 320×240 spatial resolution and still picture with 640×480 spatial resolution. A video sequence was shot by alternating two modes. For each 320×240 frame, it was down-sampled to 160×120 and had the present superresolution method applied to increase its resolution four times in both dimensions. The results for this sequence are shown in FIG. 5. Finally, the present method is compared with Bi-cubic interpolation by computing and plotting the root mean square (RMS) errors, as shown in FIG. 6 and FIG. 7.

At this point, it should be apparent to those skilled in the art that the principles of the present invention have been presented using the prior art, primal-sketch image hallucination. The present method advantageously combines information from different spatial-temporal resolution cameras by constructing a personalized dictionary from high resolution images of the scene. Thus, the prior is domain-specific and performs better than the general dictionary built from images. Additionally, the spatial-temporal constraint is integrated into the method thereby obtaining smooth and continuous videos. Advantageously, the present method may be used—for example—to enhance cell phone Video, web cam video, as well as to design novel video coding algorithms. Although it has been so described, it should only be limited by the scope of the claims appended hereto.

What is claimed is:

1. A computer implemented method of enhancing a resolution of video images comprising the steps of:
combining information received from different spatial-temporal resolution cameras including at least one high resolution image.
Constructing a personalized dictionary from the high resolution image; and
Applying the dictionary information to an image to obtain a super-resolution image.
